(19) United States
(12) Patent Application Publication
(10) Pub. No.: US 2010/0188786 A1
(43) Pub. Date: Jul. 29, 2010

(54) Fault Current Limiter

(75) Inventor: Francis Anthony Darmann, New South Wales (AU)

Correspondence Address: FAY KAPLUN & MARCIN, LLP, 150 BROADWAY, SUITE 702, NEW YORK, NY, 10038, US

(73) Assignee: AUSTRALIAN SUPERCONDUCTORS PTY LTD, Lucas Heights (AU)

(21) Appl. No.: 12/664,558

(22) PCT Filed: Jul. 9, 2007
(86) PCT No.: PCT/AU2007/000942

§ 371 Date: Dec. 14, 2009

(51) Int. Cl. H02H 9/02

(52) U.S. Cl. 361/19; 361/93.9

(57) ABSTRACT

A method is for suppressing induced steady state and transient currents and voltages in the DC circuit and coil of a magnetically saturated core fault current limiter. The method includes the steps of: (a) providing a first current coil connected to a DC power source surrounding the core for magnetically saturating the core; and (b) providing a second resistive current coil surrounding the core and either short circuited or interconnected to the DC power source in parallel to the first current coil and wound around the core in a forward or reverse sense to the first current coil.

### FIELD OF THE INVENTION

The present invention relates to superconducting fault current limiter devices.

### BACKGROUND

The utilization of superconducting fault current limiters is well known as having an enormous potential in protecting electrical circuits from phase to phase faults and phase to ground faults.

Examples of superconducting fault current limiting devices can be seen in: U.S. Pat. No. 7,193,825 to Darmann et al; U.S. Pat. No. 6,809,910 to Yuan et al; U.S. Pat. No. 7,193,825 to Boenig; and US Patent Application Publication Number 2002/0018327 to Walker et al. Taking the example of Darmann, these devices may operate by means of a DC biasing coil being placed around a magnetic core to bias the core into magnetic saturation. Upon the occurrence of a fault, the core is taken out of saturation which induces a substantial reluctance to the fault. Other current limiting devices often utilize the manipulation of the magnetic properties of a core.

During operation of most fault current limiting devices, substantial current fault may pass through the AC circuit of the device. This induces a corresponding transient voltage and current into the DC circuit of the device. The superconducting coil itself, inter-connections, cryostat feedthroughs, the DC power supply, and the power supply filtering (eg. capacitors), and protection devices (For example, Diodes, Transistors) must be selected or designed to withstand the worst case magnitude of the expected transient voltage, current, and net energy transferred during the transient period.

An example of this problem is illustrated in FIG. 1 and FIG. 2 which illustrate the simulation of a fault on an aforementioned device due to Darmann. In FIG. 1 there is illustrated a time voltage graph of a simulated fault occurring at t=4.000 seconds. In FIG. 2 there is illustrated a corresponding induced current flow in a DC superconducting biasing coil. It can be seen that there is a large potentially damaging induced current at time t=4.000 seconds and beyond. The simulation results show a 500V transient voltage can be induced with over 1.1 kA of peak current. Such transients may damage the DC power supply to the coil and the DC coil itself.

It is difficult to reduce this transient induced current because it is effectively driven by the transformer effect between the AC and the DC coils and is hence a function of the fault current which is system dependent. It can be reduced if the AC side voltage is reduced but that is fixed and application dependent (for example: 11 kV, 22 kV etc).

The transient induced current may also be reduced by lowering the turns ratio between the DC and AC side - this requires increasing the number of turns on the DC coil which may be impractical for the fault limiting percentage required in the application under consideration or it may too expensive. Alternatively, the number of turns on the AC side may be reduced, however, this will reduce the effective impedance of the device for limiting fault currents. The transient impedance of the device is proportional to the square of the number of AC turns. Reducing the effective impedance through lowering the number of AC turns is a disadvantage because to compensate for this, the cross sectional area of steel would have to be increased making the design larger, heavier, and more expensive.

In addition, it must be noted that during the steady state operation of the device, an induced current and voltage is also present in the DC circuit as a result of the induction from the AC side. These are far lower in magnitude than those induced during the fault current limiting event, but nevertheless, this effect must be allowed for in the design of the DC coil power supply interface circuit. For example, by providing sufficient capacitance to ground to sink the current away from the DC power supply.

Any discussion of the prior art throughout the specification should in no way be considered as an admission that such prior art is widely known or forms part of the common general knowledge in the field.

### SUMMARY

It is an object of the present invention to provide an effective method of significantly reducing the induced steady state and transient voltage and/or currents in the DC circuit of a fault current limiter.

In accordance with a first aspect of the present invention, there is provided a method of suppressing transient currents in the DC circuit a magnetically saturated core fault current limiter, the method including the steps of: (a) providing a first current coil surrounding the core for magnetically saturating the core connected to a DC power source; (b) providing a second resistive current coil surrounding the core interconnected to the DC power source in parallel to the first current coil and wound around the core in a reverse sense to the first current coil.

The first current coil can be a superconducting coil. The core can be interconnected between the supply and load of each phase of a power supply and the fault current limiter limits current through each phase of the power supply. The second resistive current coil can be spaced apart from the first current coil. The second resistive current coil can be interleaved with the first current coil. The core can be interconnected between the DC power supply and load of each phase of a power supply and the fault current limiter limits current through each phase of the power supply.

In accordance with a further aspect of the present invention, there is provided a fault current limiter including: at least one magnetically saturable core; a first current coil wound around the core and interconnected to a DC power source for magnetically saturating the core; a second current coil wound around the core in a reverse sense to the first current coil and interconnected in parallel with the first current coil to the DC power source.

The first current coil can be a superconducting coil. The core can be interconnected between the supply and load of each phase of a power supply and the fault current limiter limits current through each phase of the power supply. The second resistive current coil can be spaced apart from the first current coil. The second resistive current coil can be interleaved with the first current coil. The core can be interconnected between the supply and load of each phase of a power supply and the fault current limiter limits current through each phase of the power supply.

The resistive current coil is ideally electrically insulated from the first current coil and may be either immersed in cryogen, cooled to the same temperature as the first current coil, or it may be at ambient temperature. It may be in the shape of a flat disk or a cylinder and may form either a short circuit electrically insulated from all other coils or it may be electrically connected to the DC biasing coil.

### BRIEF DESCRIPTION OF THE DRAWINGS

A preferred embodiment of the invention will now be described, by way of example only, with reference to the accompanying drawings in which:

FIG. 1 illustrates a graph of the calculated induced EMF in a DC coil of the prior art upon the occurrence of a fault condition;

FIG. 2 illustrates a graph of the calculated induced current within a DC coil of a fault current limiter when subjected to a simulated fault condition; FIG. 3 illustrates schematically the incorporation of a DC dampening coil (also known as the compensation coil or resistive coil) into a Fault current limiter;

FIG. 4 illustrates a graph of the calculated induced EMF in a DC coil of the preferred embodiment upon the occurrence of a fault condition;

FIG. 5 illustrates a graph of the calculated induced current within a DC coil of a fault current limiter of the preferred embodiment when subjected to a simulated fault condition;

FIG. 6 illustrates a side perspective view of a multi phase fault current limiter;

FIG. 7 illustrates a sectional plan view of a single phase arrangement;

FIG. 8 illustrates a side perspective view of an alternative form of multi phase fault current limiter;

FIG. 9 illustrates a top view of the limiter of FIG. 9; and

FIG. 10 illustrates a simulation result for the arrangement of FIG. 8 when subjected to a simulated fault current.

### DETAILED DESCRIPTION

In the preferred embodiment a second coil is utilised in conjunction with the Superconductor coil to reduce the effects of any transient induced currents and voltages in the Superconducting coil and DC circuit. The preferred embodiment will be discussed with reference to the aforementioned system to Darmann.

In FIG. 3, there is illustrated schematically the arrangement of a single phase version of the preferred embodiment 10. In this arrangement, a laminated steel core 10 is provided. On one side a source 11 is interconnected to a primary core 12 wound around a ferrous or other high permeability material arm. Further, a load 14 is interconnected to a secondary winding 15. Around the central arm 16, two coils are formed, including an outer superconducting biasing coil 17 and an inner DC dampening coil 18 which can be formed from copper wire or sheet and is connected in parallel with the superconducting biasing coil 17. In an alternative embodiment, the coil 17 maybe left unconnected to anything electrically and is short circuited. The superconducting biasing coil 17 acts to bias the core arm 16 into magnetic saturation (as provided by the prior art). The DC dampening coil 18 can be separate from the superconducting biasing coil 17 and does not need to be cryogenically cooled nor electrically connected to the biasing coil. The DC dampening coil 18 acts to dampen out induced transient oscillations in the fault current limiter 10.

During the steady state operation, the AC coils induce a small flux into the steel cores. This makes the steel core flux oscillate around a minor hysteresis loop. This small perturbation of flux results in an induced EMF and induced current in the DC saturating coil. During normal steady state operation, this induced current is relatively small compared to the DC supply current and the induced EMF is small. For example, if the AC line current is 1000 Amps AC rms and the turns ratio between the AC and DC coils is 100, then there will be a current of 10 Amps AC rms induced into the DC circuit of the saturated fault current limiter. This results from the basic transformer effect as described by Equation (1) below:

I (Induced into DC coil)=(n/N)*I (AC_circuit) Equation [1].

### Where:

N=Number of DC turns

n=Number of AC turns

More generally, the net electrical current in the DC coil at any time t is then equal to the driving current from the power supply and that induced into it from the AC circuit:

I (DC coil)=I (Power Supply)+I (Induced into DCcoil) Equation [2].

Similarly, when the core is unsaturated, the induced sinusoidal steady state EMF induced in the DC coil will follow the well known steady state transformer Equation:

V=4.44*Bₚₑₐₖ*N*A*f Equation [3].

### Where:

V=The RMS voltage induced into the DC coil from the AC side [Volts]
Bₚₑₐₖ=The Peak of the Sinusoidal Steady State magnetic field in the FCL core [Tesla]
A=Cross sectional area of the core [m²]
f=AC system frequency
N=number of turns on the DC coil

Similarly, the DC dampening coil, during the steady state operation of the device, also has a sinusoidal steady state current induced into it according to Equation [4]

I (Induced into compensation coil)=(n/ν)*I (AC_circuit) Equation [4].

where ν is the number of turns on the compensation coil and which may be equal to a single turn in some cases. This is also true in both the unfaulted steady state and faulted steady state situations (i.e. when a fault occurs on the AC line). The induced current in the compensation coil is of opposite polarity to the current in the AC line and as such will set up a flux in the central cores which is of opposite polarity to that originating from the AC coils.

The effect of the compensation coil in the transient period between the unfaulted steady state and the faulted steady state is ideally simulated utilizing appropriate numerical methods to solve for.

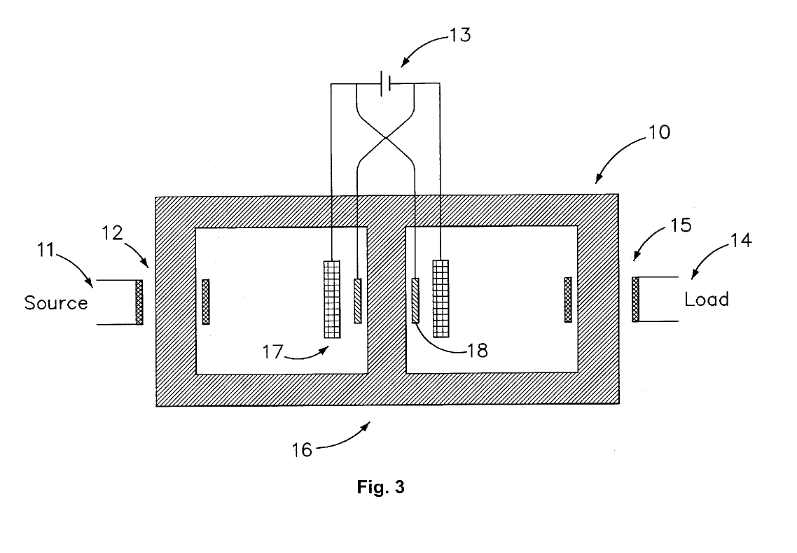

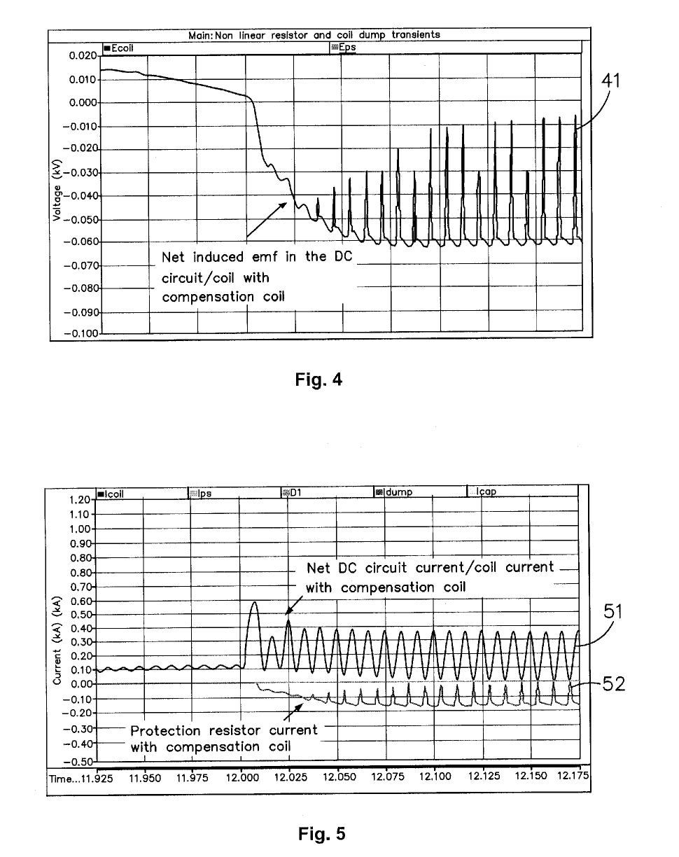

For example, FIG. 4 illustrates a voltage output waveform 41 of a simulated fault on the AC circuit for the arrangement of the preferred embodiment, with FIG. 5 illustrating the net current 51 in the biasing coil circuit and the current in the quench protection resistor 52. The core was saturated to a value of 2.0 Tesla and the AC perturbation in the steady state was approximately from −1.9 Tesla to 2.1 Tesla. Other parameters employed in this circuit simulation were as follows:
The number of AC turns was 40 on each of the six limbs (n=40),
The number of DC turns was 800 (N=800),
The DC bias current was 90 Amps. I(Power_Supply)=90 Amps,
The AC voltage source employed was 11 kV AC RMS line to line,
The AC circuit load was 9 Ohms (Unfaulted steady state load)
The short circuit load (i.e. the fault impedance) employed was 0.04 Ohms,
The prospective short circuit current was 10,000 Amps,
The core area of permeable material was 0.02 square meters,
The core window dimensions employed were 0.8 m wide×2.2 m high, and
The time of the fault occurring was t=4.000 seconds
The dampening coil used in the simulation was equivalent to 800 turns of copper conductor and was capable of carrying the expected induced current.

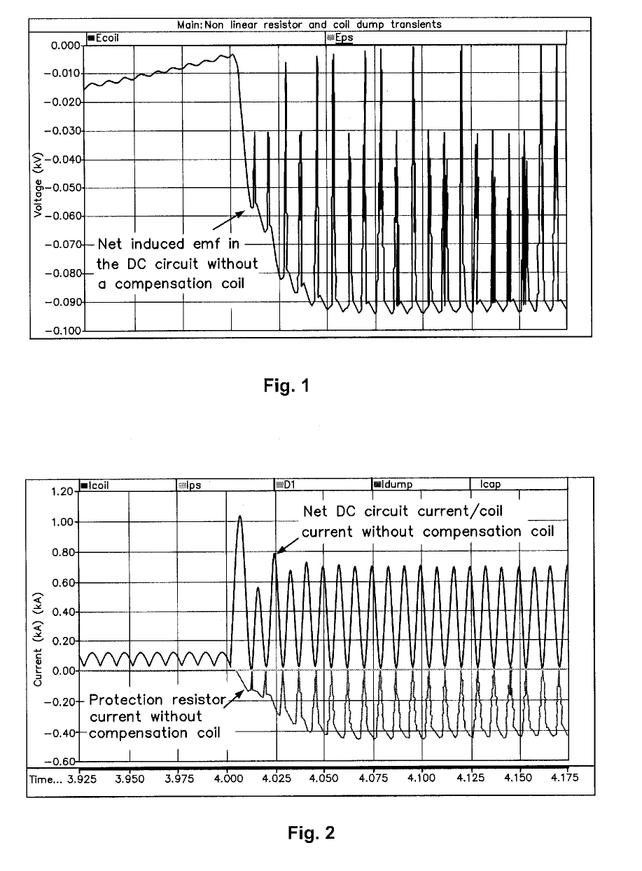

FIG. 4 and FIG. 5 illustrate a substantial reduction in the induced current transient and voltage transient in the DC circuit and through the superconductor biasing coil during the fault event on the AC side of the circuit. The peak current transient after the fault on the AC side was found to be reduced from a magnitude of 1.1 kA (without the compensation coil) to 0.55 kA (with compensation coil) (FIG. 2). The peak voltage transient after the fault on the AC side was found to be reduced from a magnitude of 93V (without compensation coil) to 63V (with compensation coil) (FIG. 4).

Depending on requirements, the dampening coil 17 may be wound over the superconducting coil, under it, or it can be in the cryostat or outside of the cryostat, provided it is wound around the central limbs of the saturated fault current limiter. It must of course be connected electrically in parallel with the DC coil, not in series, and it may also form a short circuit and not be connected to anything else. Hence, the DC coil could be formed from a cylinder of copper sheet suitably sized in thickness, will also damped the steady state and transient induced current and voltage in the DC circuit and coil.

In a multiphase arrangement, the DC compensation coil 18 can be wound around each of the transformer cores and connected electrically in parallel with the superconducting DC coil 17.

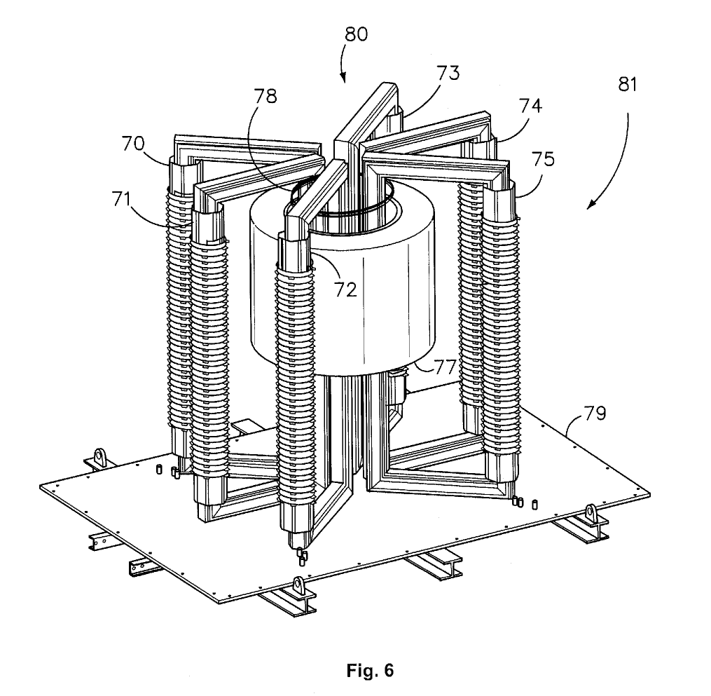

FIG. 6 illustrates a side perspective view of a part of a multiphase arrangement. In this arrangement there are three input coils 70,71,72 wound around corresponding arms, and 3 output coils 73,74,75, again wound around corresponding arms. Each of the arms form part of a loop with the other part of the loop forming part of core 80. It can be seen that both the superconducting coil and cryostat 77 and the DC compensating coil 70 are each wound around the six phase arms of the multi phase arrangement so as to provide fault current limiting capabilities to each of the phases.

The arrangement 81 has the significant advantage that the DC coil 78 can be formed separately from the superconducting coil 70 and hence does not need to be cryogenically cooled.

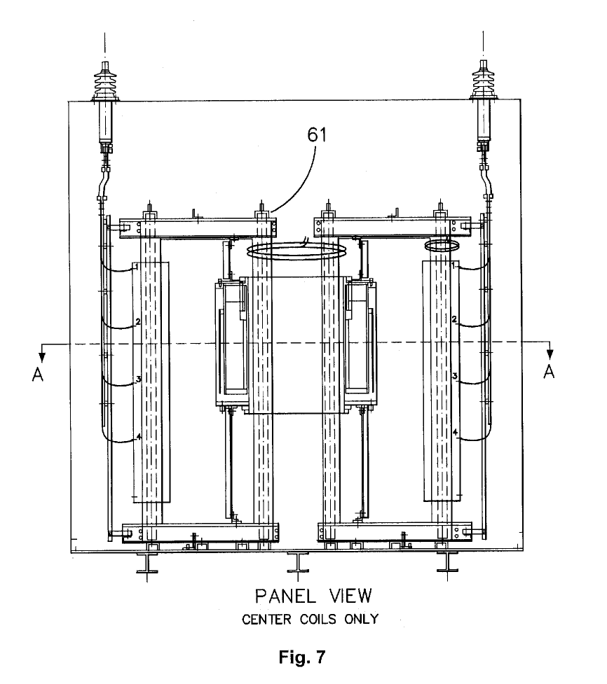

FIG. 7 illustrates design drawings of a side on plan view of a single phase of the arrangement of FIG. 6, with a first superconductor cryostat and coil 60 and a second DC coil 61 shown schematically.

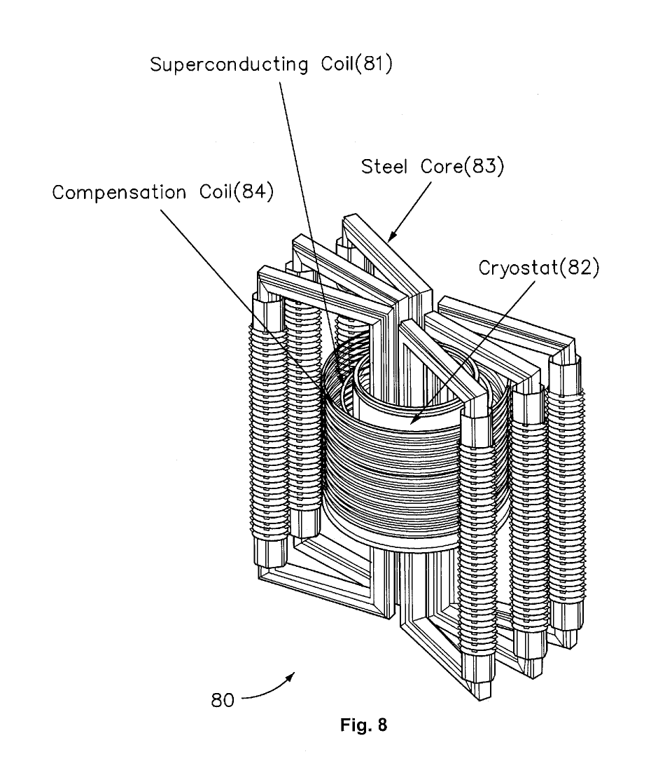

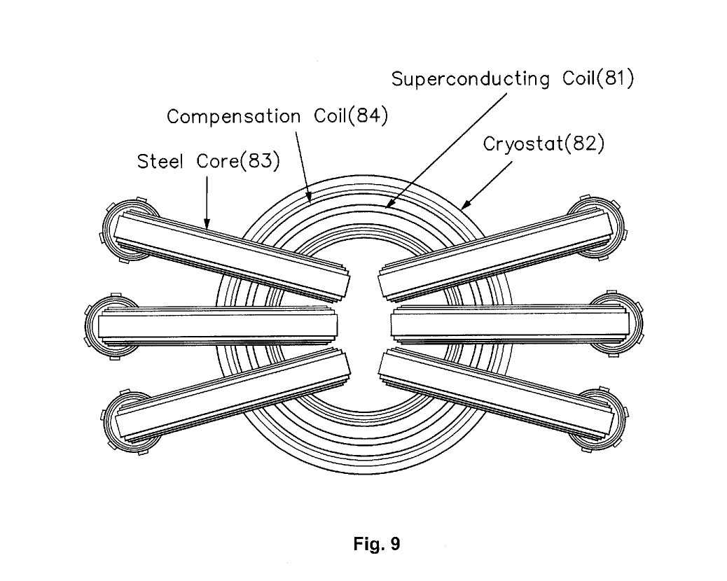

FIG. 8 illustrates a side perspective view of the essential portions of a further modified arrangement of a multiphase fault current limiter with a superconducting coil 81 in a cryostat 82, formed around a laminated steel core 82. The compensation coil 84 is provided within the cryostat in this example. This can be seen more clearly in FIG. 9 which is a top plan view of the arrangement of FIG. 8.

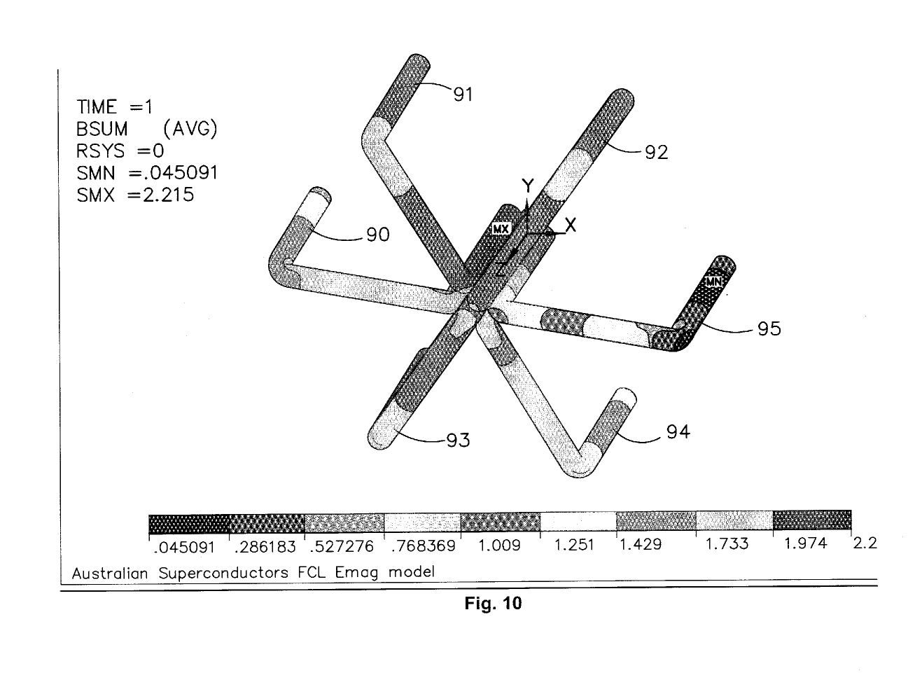

In FIG. 10, there is shown one simulated snap shot in time of the flux in a high permeability core of a saturated fault current limiter for the arrangement of FIG. 8. In this snap shot, 5 of the 6 outer limbs and the central core were found to be biased to 2.00 Tesla. Each of the 5 AC coils on these 5 limbs 90-94 will have a low impedance. The coil wound on the limb 95 with the low flux of approximately 0.045 Tesla will have a high impedance. Hence, at this moment in time, two phases of the three phase device have a low impedance, and one phase has a high impedance. This is the mechanism by which the saturated fault current limiter can act to reduce fault current magnitudes.

It will be evident to those skilled in the art that the arrangement illustrated can be used in both single and multiphase systems. Although the invention has been described with reference to specific examples it will be appreciated by those skilled in the art that the invention may be embodied in many other forms.

1-18. (canceled)

19. A method for suppressing a steady state and transient induced one of currents and voltages in a DC circuit of a magnetically saturated core fault current limiter, comprising:
(a) providing a first current coil surrounding the core for magnetically saturating the core connected to a DC power source; and
(b) providing a second resistive current coil surrounding the core.

20. The method of claim 19, wherein the second resistive current coil is interconnected to the DC power source in parallel to the first current coil.

21. The method of claim 20, wherein the resistive current coil is wound around the core in a reverse sense to the first current coil.

22. The method of claim 19, wherein the second resistive current coil is short circuited.

23. The method of claim 19, wherein the first current coil is a superconducting coil.

24. The method of claim 19, wherein the core is interconnected between the supply and load of each phase of a power supply and the fault current limiter limits current through each phase of the power supply.

25. The method of claim 19, wherein the second resistive current coil is spaced apart from the first current coil.

26. The method of claim 19, wherein the second resistive current coil is interleaved with the first current coil.

27. The method of claim 19, wherein the core is interconnected between the supply and load of each phase of a power supply and the fault current limiter limits current through each phase of the power supply.

28. A fault current limiter, comprising:
at least one magnetically saturable core;
a first current coil wound around the core and interconnected to a DC power source for magnetically saturating the core; and
a second current coil of at least one turn arranged around the core.

29. The fault current limiter of claim 28, wherein the second current coil includes an electrically conductive cylinder.

30. The fault current limiter of claim 28, wherein the second conductive coil includes a multi-turn coil wound in a reverse sense to the to the first current coil.

31. The fault current limiter of claim 28, wherein the second current coil is electrically interconnected in parallel with the first current coil to the DC power source.

32. The fault current limiter of claim 28, wherein the first current coil is a superconducting coil.

33. The fault current limiter of claim 28, wherein the core is interconnected between the supply and load of each phase of a power supply and the fault current limiter limits current through each phase of the power supply.

34. The fault current limiter of claim 28, wherein the second resistive current coil is spaced apart from the first current coil.

35. The fault current limiter of claim 28, wherein the second resistive current coil is interleaved with the first current coil.

36. The fault current limiter of claim 28, wherein the core is interconnected between the supply and load of each phase of a power supply and the fault current limiter limits current through each phase of the power supply.
